(19) United States
(12) Patent Application Publication
(10) Pub. No.: US 2024/0107631 A1
(43) Pub. Date: Mar. 28, 2024

(54) A SYSTEM AND METHOD FOR CONTROLLING QUALITY OF COOKING

(71) Applicant: GARDA TECH LTD, Beer Ganim (IL)

(72) Inventors: Sagie TSADKA, Meishar (IL); Netanel FARKASH, Beer Ganim (IL); Moty BENTOLILA, Beer Ganim (IL)

(73) Assignee: GARDA TECH LTD, Beer Ganim (IL)

(21) Appl. No.: 18/038,715

(22) PCT Filed: Nov. 25, 2021
(86) PCT No.: PCT/IL2021/051405

§ 371 Date: May 25, 2023

Related U.S. Application Data
(60) Provisional application No. 63/118,662, filed on Nov. 26, 2020.

(51) Int. Cl. H05B 1/02; F24C 3/12; F24C 7/08

(52) U.S. Cl. CPC H05B 1/0266; F24C 3/126; F24C 7/087; H05B 2213/07

(57) ABSTRACT

This invention relates to a multi-sensor system and method for automatic control of cooking appliances, and more particularly it relates to the save of energy when cooking food, on any kind of cooking ware.

### FIELD OF THE INVENTION

This invention relates to a multi-sensor system and method for automatic control of cooking appliances, and more particularly it relates to the save of energy when cooking food, on any kind of cooking ware.

### BACKGROUND OF THE INVENTION AND PRIOR ART

The system and method significantly improve the quality of serving of dishes in restaurants, hotels, catering facilities and similar places, as well as private premises, by keeping standard and persistent cooking procedures in all times, by preventing over or under cooking of food, save lost dishes that are being thrown away due to over or under cooking, and also save energy while cooking the food. There is some prior art introducing some parts of similar system but all of them lack the most important parts of this invention therefore, the invention introduces a most needed new system.

US20150285513A1(to Filippo Matarazzi et al. 07.04. 2014) describes a scanning 5 sensor within an oven, wherein this sensing device configured to provide indications about the cooking of the food and nutritional values of the food based on information about its volume, the shape of the food, the weight of the food, and a typology of the food, through a comparison with third reference information stored in a memory of a system/oven software. The claims of the patent fail to cover thermal properties of the food being cooked and also fail to cover a feedback mechanism for the oven heating power based on the temperature of the food being cooked.

U.S. Ser. No. 10/819,905B1(to Qiang Liu et al. 13.09.19) describes an oven including a control unit, a display, and a cooking chamber, wherein the cooking chamber includes 2 cameras: a first camera that includes an array of thermal image sensors corresponding to a specific resolution, a second camera that includes a second array of color image sensors corresponding to a second resolution higher than the first resolution, one or more heating elements, and a food support platform. The claims of this sensor system are very specific and describe a system and method to determine the temperature of a food based on the difference between 2 thermal cameras separated by a distance and resolution positioned in an oven. As such, the claims fail to describe a single thermal imager that can extract a temperature profile of a food item being cooked in an open range, and also fails to cover any feedback mechanism to the heat level related to the cooking process and the temperature profile of the food detected and analyzed by the sensor and its software.

U.S. Ser. No. 10/919,144B2 (to Ryan W Sinnet et al. 06.03.2017) describes a robotic arm that can perform a full cooking process, mainly on a grill, by placing and flipping multiple food items cooked on the grill. The robotic arm is being managed by sensors such as RGB and IR cameras, and by a processor that runs CNN software to identify the place and shape of the food item on the grill. The claims related to the IR camera are dealing with its role to help identify the accurate shape and placement of the food item on the grill and fails to claim a role in identifying temperature profiles of the food being cooked and following its degree of readiness in the cooking process. It also fails to claim any feedback to the gas or electrical power system to increase or reduce the heat for cooking.

US020170332841A1 (to Michael Reischmann 23.05 2016) describes a cooking temperature sensor having a controller including a thermal imaging camera which identifies a food item in a cooking environment. The display is in communication with the controller and the controller transmits data representative of the food item for display. The controller monitors a thermal value of the food item and generates an alert indicative of when the temperature is reached for the food item. This system is limited to temperature and does not teach any other characteristic of this invention.

U.S. Ser. No. 10/092,129B2 (to Jonathan A. Jenkins et al. 19.08.2014) describes a control system based mainly on standard temperature sensors located in and around the cooking tool and cooking pan, that send the data to a main processing unit and control the gas flow through a motorized knob for optimal cooking process. The claims fail to cover the main points of this invention. There is no claim on high resolution thermal and visible combined camera that scans, detects and analyzes in real time the temporal and spatial temperature profile of the food being cooked. This major claim that is in the heart of this invention also uses AI and machine learning algorithms to translate the temperature and visible profile to a full cooking process without the need to sense the temperature of the cooking ware or the food using a local temperature sensor, as done in U.S. Ser. No. 10/092,129B2. The current patent also fails to explain how a single sensor or a camera placed above the cooking tool may get enough information on the temperature profile of the tool and the dish, assuming different materials emissivity will not translate accurately the proper temperatures based on standard thermal imaging. Furthermore, it gives no solution to the need to cover large area with very high resolution. The resolution is mandatory to decide on the progress of the cooking process in food such as meat grilling, where the difference in temperature of the edges to the core are crucial for decision on the progress of the cooking process. The current patent emphasizes the motorized knob for gas range and its suggested structure. It gives specific design for such a knob. However, the claim is 5 based on a drive motor contained within the control knob, therefore fails to block any solution that drive the knob with external motor, or control directly the gas valve position, which is part of this invention.

WO2020144445A1 (to Bailey Samuel Gerard 11.01.2019) describes a monitoring system for safe operation of gas hobs, based on thermal imaging camera located above the gas hob. The main claims of the patent focus on a system and method to build a temperature map of the gas hob itself, and also of the cooking ware used on the hob (stove), and to alert the user in case of extreme situation related to this temperature map (such as overheating of some areas of the hob, fire alert, etc.). The method and system claimed in this patent do not cover the case of monitoring the temperature profile or temperature in general of the food being cooked on the hob itself, and neither claim automatic control of the cooking process through automatic change of the gas valves or knobs. Most of the claims are related to the method of sending various types of alarms to the user to take care of the cooking process and be aware of extreme situation, therefore this publication is different from this invention.

### SUMMARY OF THE INVENTION

The invention disclosed is of a complete system and algorithm that allow one to control and maintain the quality of cooking of any kind of food, on any kind of cooking appliance, and save energy while doing so.

The energy source may be all kinds of cooking gas (LPG, natural gas, etc), electricity or any other known method to heat, boil or fry food products in the kitchen.

The system contains a heat seeking scanning sensor integrated with a visible multifunctional sensor and other invisible light sensors that look over the cooked food at all times, and a software, algorithm and control valves and electromechanical knob, (gas valves, gas knobs or electricity regulators or any other relevant valve or knob), that work together with the sensors to analyze the heat profile of the food, that is being cooked, and control the energy flow in a way that will keep each part of the food at the right temperature along the cooking process. By using AI (Artificial Intelligence) tools, the cooking procedure is overlooked and may recommend the user how to cook the food based on best known methods in the industry for the specific food.

The knobs of the appliances are smart instruments having electronic display on their front face or close to it, displaying the temperature of the food being cooked as well as other relevant information such as the cooking time and overcooking alerts.

The sensors' resolution and field of view enable to see and resolve each food cooked on each of the flames on the gas-based appliance, griddle, or grill in real time. The CPU is controlling the electro-mechanical gas knobs (smart knobs) that regulate the gas flow from the gas source to the different gas flames on the cooking appliance. These smart knobs change the gas flow from any value from to maximum gas flow, as set by the system administrator for each use.

The CPU use Artificial Intelligence (AI) tools and algorithms to decide which food is being cooked, what is the right temperature cycle to operate, and how to regulate the smart knobs to get the right profile and save gas.

Decisions on gas flow are very quick and immediate in order to save gas. For instance, if the user is removing a cooking ware from the gas appliance for several seconds, the system identifies the situation and shuts down the flame to a minimum in order to save gas, and obviously, do the opposite once the user returns the cooking ware to the flame.

Such a sensing and controlling system may be implemented also with other cooking methods, specifically cooking appliances based on electricity ranges, griddles, stoves, hot plates, induction heating plates and heating appliances and more (hereinafter: “appliances”), where instead of controlling the gas flow to change the temperature profile, the system controls the electricity power and/or the power profile of the appliance to get the right results for optimal cooking.

Other objects and features of present invention will become apparent from the following detailed description considered in conjunction with the accompanying drawings. It should be understood, however, that the drawings are designed solely for the purpose of illustration and not as a definition of the limits of the invention.

### BRIEF DESCRIPTION OF THE FIGURES

FIG. 1—shows an image of one embodiment of the system.

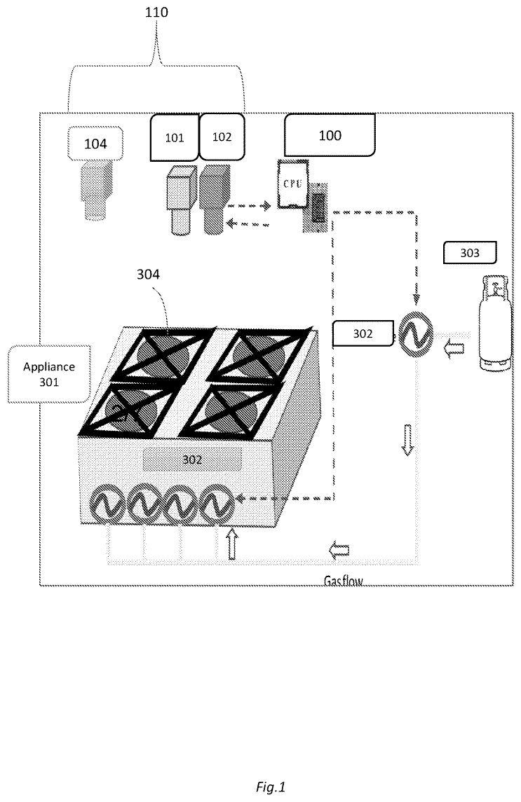

FIG. 2—shows an illustration of a Multi Sensor Unit (MSU) 200 that is located above the cooking area and contains sensors 101/102 and 104 of the system.

FIG. 3—shows an illustration of the overall cooking control system.

FIG. 4—shows an illustration of an overall control system for a gas-based cooking appliance 301.

FIG. 5—shows an illustration of another embodiment of the system: a cooking5 appliance being an electrical based appliance 400 that is controlled by an electronic adaptor 401.

FIG. 6—shows an image of an electro-mechanical gas knob 302.

FIG. 7—shows a structure of an electro-mechanical gas knob 302.

FIG. 8—shows an image of an UGM-G6 Smart Meter 300.

FIG. 9—shows a flow chart of the energy saving cooking process.

### DETAILED DESCRIPTION OF THE PREFERRED EMBODIMENTS

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. It is understood that the phraseology and terminology employed herein is not to be construed as limiting and are for descriptive purpose only.

The present invention relates to the field of multi-sensor system and method for automatic control of cooking appliances.

The invention discloses a complete system and algorithm that controls and maintains the quality of cooking of any kind of food, on any kind of cooking appliances, and save energy while doing so.

The System comprises a fast Central Processing Unit (CPU) 100, comprising processing unit (PU) 202, operating a sensing mechanism based on thermal, invisible and visible light range (hereinafter “scanning sensors”) 110. The images from scanning sensors 110 are being transferred in real time to CPU 100 that processes the images and extracts temperature profiles as well as visible profiles of the food being cooked, to smart knobs 302.

Scanning sensors module 110 consists of at least two scanning sensors, one in the thermal range 104 and the other in the visible range 101 taking both visible and thermal images and present them as separate images or combine them automatically into one temporal and spatial temperature profile of food being cooked.

Sensors 101/104 cover at least an area of 2 m×2 m with resolution of at least 1.2 cm×1.2 cm in the thermal range and 1.4 mm×1.4 mm in the visible range, seeing and resolving the cooked food on each of flames 304 on the gas range, griddle or grill in real time, with temperature sensing range of at least −20° C. up to at least 400° C. in precalculated stages of ° C.

The following main functions of sensors 101/104 support tight control of the cooking procedures, while integrated with proper processing and AI tools:

The thermal sensor 104
a. measures the food temperature before start of cooking (frozen, cold, warm);
b. drafts the temperature profile of the food throughout the whole cooking cycle;
c. watches and monitors the temperature profile of the cooking ware (hot/cold areas) and starts/stops/reduces gas or electricity flow to save cost and optimize cooking results.
d. sets Start/Stop points for the cooking process based on external temperatures;
e. detects external fire or heat sources for safety and security;
f. supports maintaining thermal uniformity of the cooked food.
g. Indicates hot points on appliances to prevent burns.

The Visible sensor 101
a. detects and monitors food shape and color, before and while cooking to assure best results for the cooking process;
b. detects signs of smoke, burned parts, unnecessary bubbles etc., while cooking;
c. automatically detects the type of food being cooked, to prevent mistakes and false cooking procedures;
d. detects open fire with no cooking ware on flame or heat source.

An exterior temperature sensor may be used. It may be of any type (such as Thermocouples, bi-metal thermostat, thermistor, RDT, IR sensor or any other known technology to measure heat and/or temperature) may be integrated into the system and positioned near cooking appliance or attached to a cooking ware or within the cooked food.

The exterior temperature sensor may accurately measure the temperature of the food in real time, and it may send an electrical signal to CPU 100.

CPU 100 then uses the temperature measurements of the cooking ware to send 0 commands to smart knobs 203/302 or control valve (smart valve) 300 to reduce or increase the gas flow of the gas range and increase or decrease the temperature of the cooking ware accordingly.

Lidar sensor 102 being part of scanning sensors 110, accurately scans the 3D dimensions of the food being cooked and monitors the change in size, height and texture of the food to help analyze the status of the cooking food.

Lidar sensor 102 supports measurement of various surfaces height and structure such as the height of water in a cooking ware while cooking, the level of bubbles created in or above a cooking ware etc., in real time.

CPU 100 is controlling smart knobs 302 that regulate the gas flow from the gas source to the different gas flames 301 on cooking appliance 304.

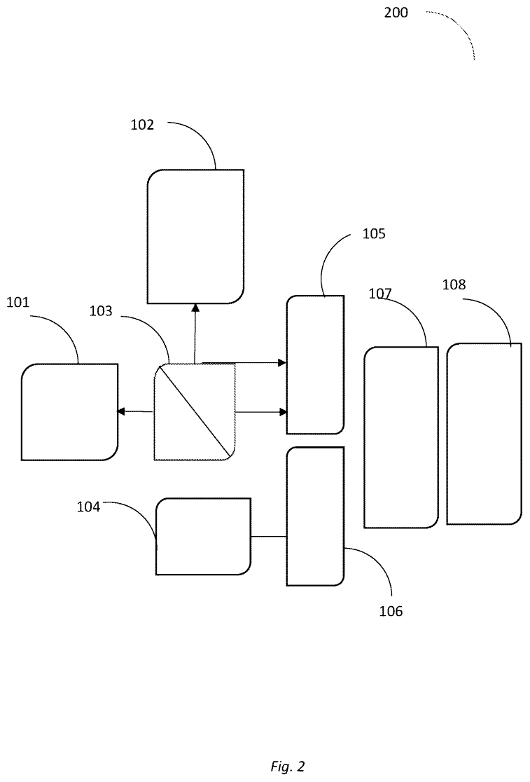

FIG. 2 illustrates the structure of the Multi-Sensor Unit (MSU) placed in any distance or angle above the cooking appliance, and contains the sensors of the system, wherein the scanning area of the cooking appliance and its surrounding area are automatically adjusted, when collecting data and transferring the data to processing unit.

MSU 200 comprises a visible camera chip 101, a measuring system that detects and locates objects on the same principle as radar but uses light from a laser (a Lidar) 102 at a programmed wavelength, an optical beam combiner 103 that transfers the light of visual camera chip 101 and reflects the light of Lidar 102, a thermal vision chip 104 with a special designed optics 106, a special designed optics 105 for the visible and Lidar wavelengths regions and, scanning mirrors 107 & 108 for the covering of a required horizontal and vertical field of view.

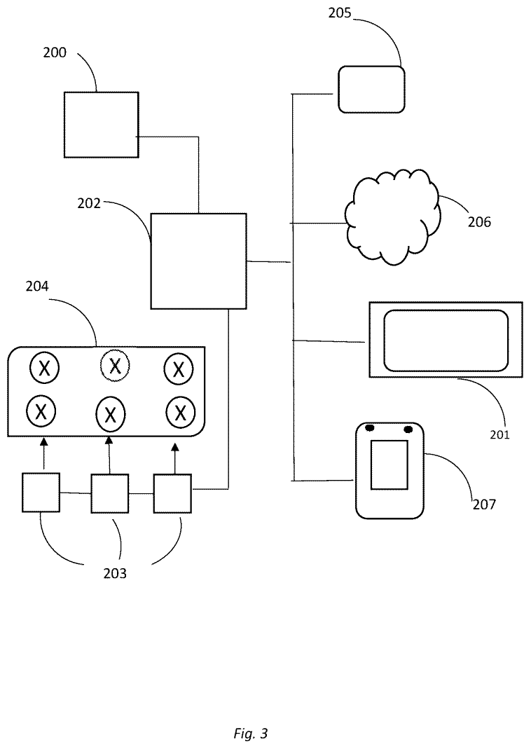

One embodiment of the cooking control system as shown in FIG. 3 comprises a 5 sensing unit MSU 200, processing unit 202 (PU) being part of CPU 100, electro-mechanical and electrical control interfaces, the cooking appliance 204, and connections and interfaces to external devices and/or services.

MSU 200 stands in a distance or angle above the cooking appliance 204, (represented in FIG. 3 as a gas-based appliance with six flames), scanning the full area of the cooking appliance 204 and its surrounding area.

Processing unit 202 contains electronic boards and processing chips that are connected to MSU 200 and control its operation, as well as grab the images and data collected by MSU 200. Processing unit 202 processes the data and run real time algorithms taking decisions as to what actions should be taken as part of the cooking 5 process that is performed by appliance 204. Processing unit 202 is also responsible of transferring the data to knobs/electrical controls 203 that control the gas flow/electric power of the cooking appliance based on decisions taken by processing unit 202.

Processing unit 202 sends data and alerts to external devices and services such as external screen 205 that presents valuable temperature and time information to the user. The data base is managed on the cloud 206, on external hardware 201 or any other control tool with communication interface such as a cellphone, Wi-Fi based terminal, iPhone/android applications, and the likes 207.

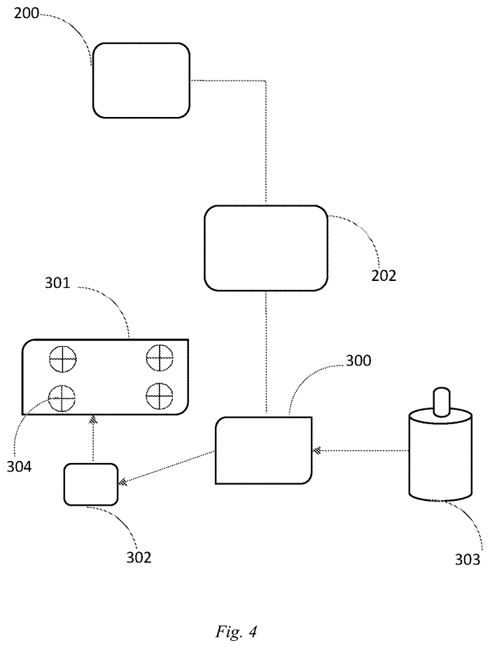

Another embodiment of the cooking control system as shown in FIG. 4, is a controlling gas-based appliance. The controlling gas-based appliance 301 actively changes the gas flow rate based on the input from processing unit 202. MSU 200 is located above the gas cooking appliance 301 and constantly monitors the cooking ware that is on the flame 304. Processor unit (PU) 202 runs real time algorithms and decisions based on the data collected in MSU 200 and controls central gas valve 300 and gas electro-mechanical knobs 302. Valve 300 limits and/or measures the gas flow from the central gas supply source 303 such as a gas cylinder or a gas storage hub.

Smart valve 300, (shown in FIG. 4), is part of the system. Valve 300 may be a gas meter with integrated needle valve (in case of control system for gas-based cooking appliance) or electric voltage control switch (in case of electric based appliance) or other type of valves that can measure and control the flow of an energy source for a cooking appliance under control.

Without limiting the generality of the invention, a gas-based valve 300 is described.

Gas-based valve 300 for a gas-based cooking appliance has two main functions in the system: it accurately measures the mass of gas that always flows through it and controls the amount of gas flow that goes through the system from zero flow (complete shutoff) to a pre-set maximum flow rate.

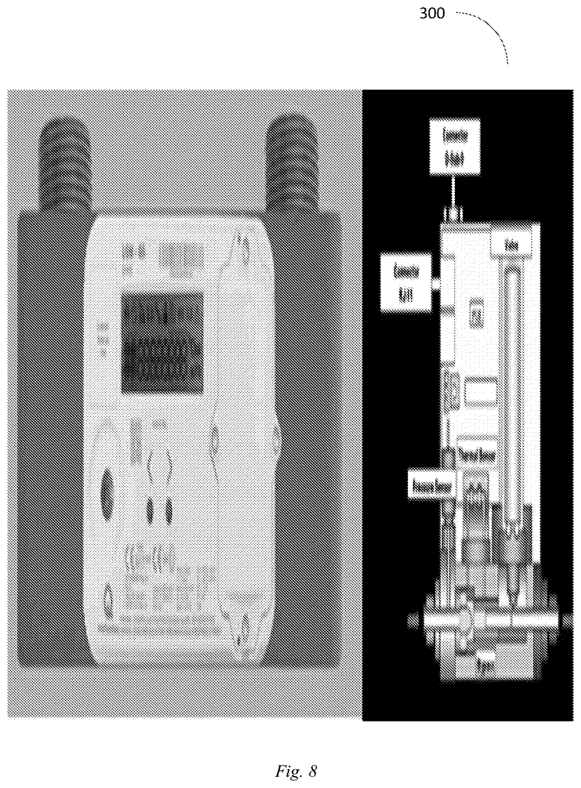

One example of valve 300 is shown in FIG. 8. It is based on UGM-G6 Gas Smart 5 Meter that is designed to measure the volume of Natural Gas and Liquefied Petroleum Gas (LPG). The measurement technology is based on an innovative ultrasonic sensor integrating a temperature sensor. This combination of sensors accurately converts volume flow into mass flow and monitors the amount of gas that flows through it under all conditions. Valve 300 may contain a controlled nozzle that changes its diameter in order to limit the gas flow.

Valve 300 may be integrated between the gas source and the gas pipes that leads to the appliance, and/or at each entry point to each one of flames 301 on the cooking appliance.

The functions of valve 300 add value to the overall system by measuring the overall consumption of gas very accurately and therefore monitors the quantity of gas being used in real time, how much gas is still left in gas source 303, sends alerts to renew the gas support on time (if relevant), and verifies the billing of the gas company preventing over charging and/or mistakes.

Valve 300 is controlled by CPU 100 to shut off in case of emergency. CPU 100 monitors valve's pressure and flow rate at all times identifying and alerting gas leaks when appliance's flames 304 are shutoff.

By comparing valves' 300 pressure and the resulted flames 304 power (detected visually by scanning sensor 101), the system identifies potential clogs in the gas pipes or gas valves which need cleaning and/or servicing.

The gas flow rate through valve 300 is controlled at all times for increasing or reducing the heating effect in each one of flames 304. Scanning sensors 110 and CPU 100 give the feedback to valve 300 on the resulted heating effect for the gas flow rate that 0 was selected and will send a revised commands to valve 300 to increase, decrease or keep steady the gas flow rate accordingly.

Valve 300 eliminates the burden of not forgetting to manually shut off or on the flame, each time a cooking ware is taken off or put on the appliance. Valve 300 with the proper CPU 100 monitoring mechanism turns on and off the gas flow based on the presence of a cooking ware on flame 304 and actions taken by the user. It saves gas and money and increases the safety of use of the appliance.

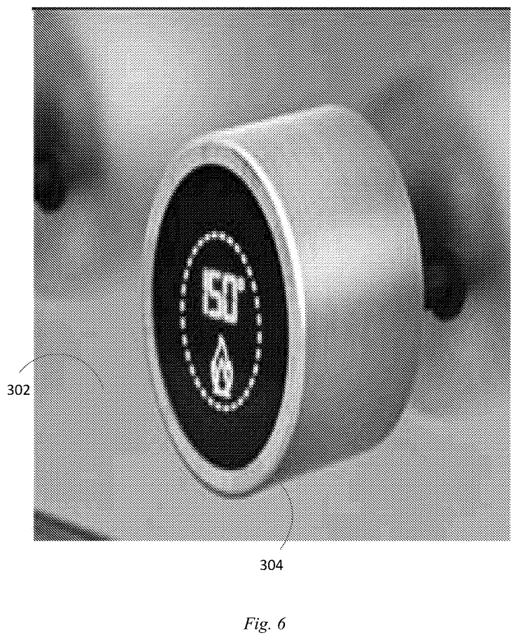

Knob 302 is an electro-mechanical device that clings onto the shaft of the regular gas knob of gas-based appliance 301. Its design is unique and allows the user to use knob 302 also in a manual way, (as done today), including pushing to turn on and ignite fire, 0 turn on or off the gas flow as necessary. Knob 302 may be turned on or off also in an automatic way using a motor and encoder that is controlled by processor unit (PU) 202 and may change the gas flow in real time without changing the external design of gas knobs 302 of appliance 301. An image of an electro-mechanical gas knob 302 is shown in FIG. 6.

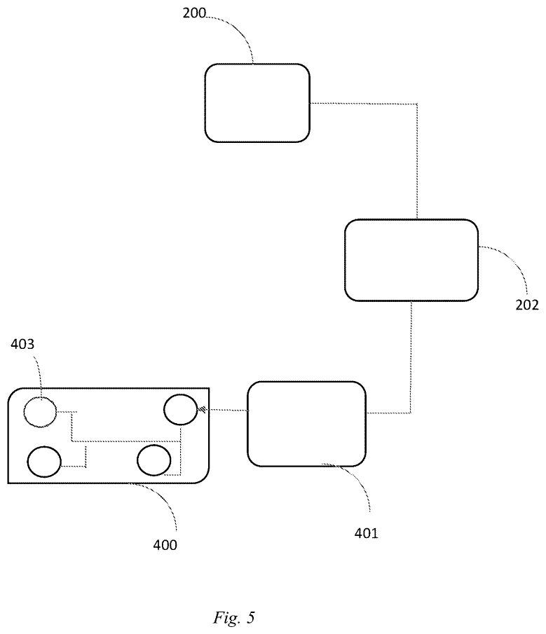

Another embodiment of a controlling electrical based appliance, similar to the one in FIG. 4, is shown in FIG. 5, but in this case, the cooking appliance is an electrical based appliance 400 that is being controlled through an electronic adaptor 401 that communicates with the internal power control board and changes the electrical power that heats up the plate 403 in any of the spots that are used for cooking ware. MSU 200 is located above appliance 400. Processing unit 202 is connected to adapter 401 and sends commands for changing the heating power of appliance 400.

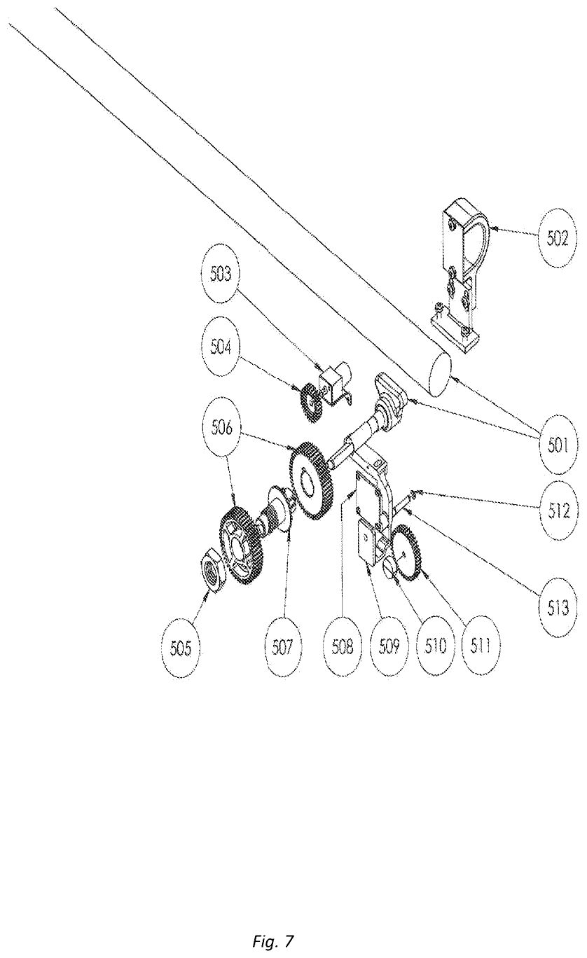

The detailed structure of the electromechanical gas knob 302 is described in FIG. 7. Gas knob 302 comprises: a gas pipe and tap 501, which is connected to the appliance, bracket on gas pipe 502, a stepper mini motor 503, a Gear Dia=18 mm on motor 504, a hex nut M12 505, a Gear Dia over bushing=36 mm 506, Bushing over tap 507, a magnet encoder PCB 508, a holding motor bracket and encoder 509, a magnet encoder 510, a Gear Dia=27 mm for encoder 511, a C-Clip M3 for pin 512 and pin Dia=3 for encoder gear 513.

FIG. 7 describes a very specific version of electromechanical mechanism gas knob 302 that rotates and controls the gas knob of a regular gas range. Part 1 (gas pipe and gas shaft/tap) are parts of a regular gas range. The other parts are designed to be attached to any fixed part inside a gas-based appliance and cling to the gas shaft and rotate it while measuring its accurate position, controlled by processing unit 202.

Smart knobs 302 change the gas flow from 0 to maximum flow, as set by CPU 100 for each user.

CPU 100 uses Artificial Intelligence (AI) and algorithms to decide which food is being cooked, what is the right temperature cycle to operate, and how to regulate smart knobs 302 to get the right profile and save gas.

The electrical motor 503 of smart knob 302 rotates the knob to any position from zero position (when the gas flow is completely shut off) to maximum position (where the gas flow is at maximal flow rate) when receiving electrical current. The same knob can be manually controlled by a user, similar to the way it is used today in commercial ranges, so the user may decide to operate the gas range by electronic control or by manual control with no restrictions on the way it is used.

Smart knob 302 gets its command from CPU 100, as described above. If the level of heating needs to be turned on, smart knob 302 is automatically rotating to the right position by CPU 100 and if heating needs to be reduced it is automatically turned off, when it detects overheating of a cooking ware that may cause burned products, fire or heavy smoke, reduces heating to a lower level, by reducing the level of gas flow thus reducing the power of heating.

Smart knob 302 has an electronic screen 304 (color or B/W, LCD, LED, OLED, T FT or any other screen that can clearly present graphics and data on its face) as shown in FIG. 6. Electronic screen 304 presents, in real time, the temperature of the content of a cooking ware that is being cooked on a gas-based appliance 301 as well as other parameters such as max and min temperatures, cooking time, alerts on overheating or under heating of content that is being cooked, etc.

The display on electronic screen 304 may contain special symbols to alert the user with information on the status of the cooking content, such as shown in the image in FIG. 6.

The following functions of CPU 100 are completing the description of the overall system functionality:
a. CPU 100 connects to scanning sensors 110 (visible, IR and thermal), acquiring images in real time and processing the images based on AI algorithms.
b. Through running image processing algorithms, CPU 100 detects, classifies, and verifies the temperature and structural profile of the content being cooked as well as the cooking ware. By using AI algorithms, CPU 100 verifies the quality of cooking through the whole cooking process by identifying temperature, color, steam, bubbles, smoke, quantity of sauce and water, size, height and shape of the food being cooked, carbon signs etc.).
c. CPU 100 communicates with valves 300 and/or with smart knob 302/203 to change the gas flow rate (or other parameters such as operating voltage if the valve/knob is electric).
d. CPU 100 collects and stores data for future use, including improving the learning process of the AI algorithms, monitoring the performance of user while cooking, and other data.
e. CPU 100 may run strong AI algorithms, including such that are based on Neural Networks, to decide in real time on the cooking quality, and change the energy flow to the cooking appliance to optimize the cooking process, and save energy consumption (gas, electricity etc).
f. CPU 100 sends data to a server in cloud 206. The data includes, for example, images of dishes while being cooked, gas consumption, gas reserve values and other relevant data.
g. CPU 100 sends alerting alarms in various ways, sound, light, calling to a fixed line or mobile phone, sending data and alarms through mobile applications, etc., notifying dangerous situations such as smoke, fire, hot parts on the appliance, spilled liquids on surfaces, overcooking of food, time laps of pre-programmed cooking plans, etc.
h. CPU 100 connects to other sensors such as temperature, smoke, CO and other dangerous gases, earthquake sensors etc., sending alerts to preprogrammed people or authorities.
i. CPU 100 may connect to the user or other preprogrammed numbers or authorities via communication of a fixed line, ethernet line, Wifi, Bluetooth, NFC, RF, or other remote control wireless solutions that exist and will be invented in the future.

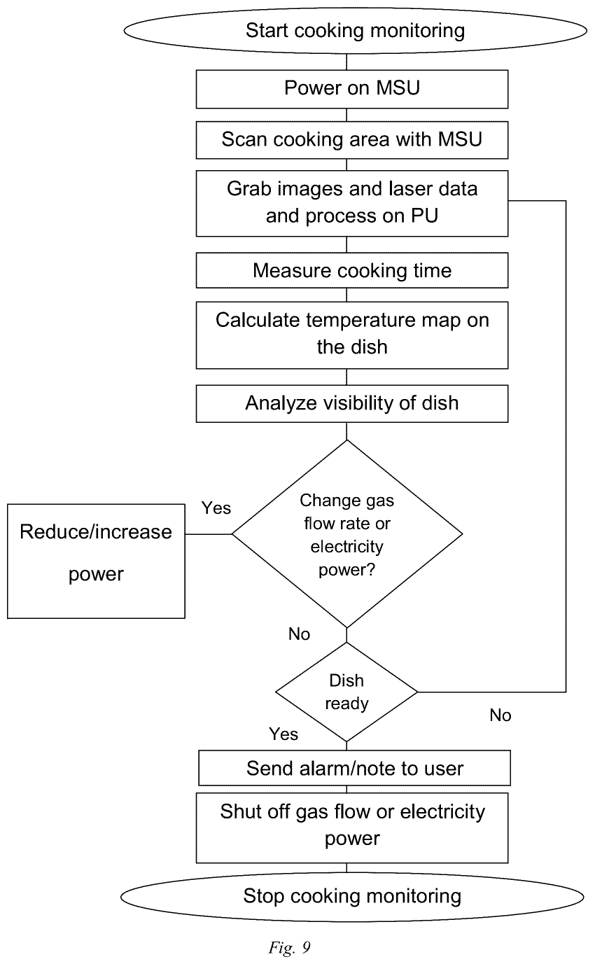

The flow chart for energy saving cooking process in FIG. 9, shows the steps taken by the system to save energy in cooking process.

1. A multi-sensor system running artificial Intelligence (AI) algorithms in real time controlling and maintaining the quality of cooking of any kind of food on any kind of appliance taking automatic decisions and actions during a cooking process comprising:
a Multi-Sensor Unit (MSU) located above a cooking area comprising a sensing mechanism based on high resolution thermal and visible range sensors (scanning sensors);
thermal and visible multifunctional scanning sensors, wherein a combination of the high resolution thermal and visible sensors scans, detects, and analyzes in real time temporal and spatial temperature profile and structure of food being cooked;
a fast Central Processing Unit (CPU) comprising a processing unit (PU) connected to the MSU, electronic boards, and processing chips, collecting images and data from the MSU;
a laser profiler Lidar sensor being part of the high resolution scanning sensors that are integrated in the MSU;
an electromechanical valve regulating gas flow from a gas source to different gas flames on a cooking appliance, or to an electrical control board or a mechanism that controls an electrical power supply to heating spots of an electrical based cooking appliance;
an electro-mechanical and electrical control interfaces connecting to external devices and/or services;
electro-mechanical gas knobs; and
a control valve or an electronic adaptor.

2. The multi-sensor system according to claim 1, wherein the Multi-Sensor Unit (MSU) is placed at any distance or angle above the cooking appliance, wherein a scanning area of the cooking appliance and its surrounding area are automatically adjusted, when collecting data and transferring the data to processing unit.

3. The multi-sensor system according to claim 1, wherein the Multi-Sensor Unit (MSU) comprises a visible range camera chip, a measuring system that detects, builds profiles and locates objects using light from a laser (Lidar) in a programmed wavelength.

4. The multi-sensor system according to claim 3, wherein the Multi-Sensor Unit (MSU) comprises an optical beam combiner transferring light of the visible range camera chip and reflecting the light of Lidar or vice versa.

5. The multi-sensor system according to claim 1, wherein the Multi-Sensor Unit (MSU) comprises a thermal chip with special designed optics and separated designed optics for the visible range camera chip and the Lidar wavelength region and scanning mirrors for horizontal and vertical fields of view of all three spectral regions together.

6. The multi-sensor system according to claim 1, wherein the thermal and visible range scanning sensors are multifunctional, take visible and thermal images and present them as separate images or combine them automatically into one temporal and spatial temperature and structure profile.

7. The multi-sensor system according to claim 1, wherein the scanning sensors cover at least an area of 2 m×2 m with resolution of at least 1.2 cm×1.2 cm in the thermal range and at least 1.4 mm×1.4 mm in the visible range with a temperature sensing range of at least −20° C. up to at least 400° C. at precalculated stages of ° C.

8. The multi-sensor system according to claim 1, wherein the thermal sensor measures food temperature before start of cooking, drafts a temperature profile of the food throughout a whole cooking cycle, watches and monitors the temperature profile of the cooking ware, and starts/stops/reduces gas or electricity flow, detects external fire or heat sources, supports maintaining thermal uniformity of a cooked food and indicates hot points on appliances.

9. The multi-sensor system according to claim 1, wherein the visible range sensor 1 detects and monitors food shape and color, before and while cooking, detects signs of smoke, burned parts, unnecessary bubbles, open fire with no cooking ware on flame or heat source and automatically detects type of food being cooked.

10. The multi-sensor system according to claim 1, wherein an exterior temperature sensor of any type may be integrated into the system and positioned near a cooking appliance or attached to a cooking ware or within the cooked food supplying actual temperature of an object it is attached to.

11. The multi-sensor system according to claim 1, wherein the Lidar sensor builds a 3D image of the food being cooked and surrounding materials, monitoring various surfaces of cooking, change in size, height and texture of the food and analyzing status of the cooked food.

12. The multi-sensor system according to claim 1, wherein the fast Central Processing Unit (CPU) receives images from the scanning sensors, processing, and extracting temperature and visible profiles of the food being cooked, sending commands and control orders to the electro-mechanical gas knobs or the control valve.

13. The multi-sensor system according to claim 1, wherein the electro-mechanical gas knobs comprise a gas pipe and tap connecting the knobs to the appliance, brackets, a stepper mini motor, Gear Dias, hex nut, and magnet encoders.

14. The multi-sensor system according to claim 1, wherein the electro-mechanical gas knobs comprise an electronic color screen, or B/W, LCD, LED, OLED, TFT or any other screen capable of presenting graphics and data on its face.

15. The multi-sensor system according to claim 13, wherein the electro-mechanical gas knobs get commands from the CPU and regulate level of heating by automatically rotating the value from 0 to maximum gas flow for each use.

16. The multi-sensor system according to claim 13, wherein the electro-mechanical gas knobs may be turned on or off in an automatic way using a motor and encoder controlled by the processor unit and may change the gas flow in real time without changing the external design of regular gas knobs of the appliance.

17. The multi-sensor system according to claim 1, wherein the control valve or electronic adaptor comprise an integrated needle valve or an electric voltage control switch that limit and/or measure the gas flow from the central gas supply source or the flow of an energy source for electrical based appliance.

18. The multi-sensor system according to claim 1, wherein the processor unit (PU) runs real time algorithms and decisions based on data collected in the MSU, and controls the cooking process through, for gas-based appliances, a central gas valve and the electro-mechanical gas knobs and, for electrical based appliances, the processor unit (PU) controls voltage through the electronic adaptor, while sending alerts of various types to a user.

19. The multi-sensor system according to claim 18, wherein the processor unit (PU) processes the images and data received from the MSU with special designed algorithms running in real time within the processing unit (PU), taking decisions on the food being cooked and sending commands and alarms to the observed and monitored appliance.

20. The multi-sensor system according to claim 17, wherein the processing unit (PU) sends data and alerts to an external hardware and services, to any control apparatus with a communication interface selected from a cellphone, Wi-Fi based terminal, and iPhone/android applications, and to an external data base whereas the data base is managed on a cloud or on an external hardware.

21. A method of saving any kind of energy used for a cooking process comprising the steps:
obtaining a multi-sensor system running artificial Intelligence (AI) algorithms in real time controlling and maintaining the quality of cooking of any kind of food on any kind of appliance taking automatic decisions and actions during a cooking process comprising:
a Multi-Sensor Unit (MSU) located above a cooking area comprising a sensing mechanism based on high resolution thermal and visible range sensors (scanning sensors);
thermal and visible multifunctional scanning sensors, wherein a combination of the high resolution thermal and visible sensors scans, detects, and analyzes in real time temporal and spatial temperature profile and structure of food being cooked;
a fast Central Processing Unit (CPU) comprising a processing unit (PU) connected to the MSU, electronic boards, and processing chips, collecting images and data from the MSU;
a laser profiler Lidar sensor being part of the high resolution scanning sensors that are integrated in the MSU;
an electromechanical valve regulating gas flow from a gas source to different gas flames on a cooking appliance, or to an electrical control board or a mechanism that controls an electrical power supply to heating spots of an electrical based cooking appliance;
an electro-mechanical and electrical control interfaces connecting to external devices and/or services;
electro-mechanical gas knobs; and
a control valve or an electronic adaptor;
starting cooking monitoring;
scanning a cooking area with the MSU;
grabbing images and laser data and processing on the processor unit (PU);
measuring cooking time;
calculating temperature map of a dish:
changing gas flow rate or electricity power, automatically reducing or increasing power based on a calculation map and stage of a cooked food;
shutting off energy;
stopping cooking monitoring.
